(19) United States
(12) Patent Application Publication
(10) Pub. No.: US 2014/0250707 A1
(43) Pub. Date: Sep. 11, 2014

(54) TELESCOPING MEASURING APPARATUS FOR RELEASABLE ATTACHMENT TO A CUTTING APPARATUS

(71) Applicant: Erven D. Erickson, Addy, WA (US)

(72) Inventor: Erven D. Erickson, Addy, WA (US)

(21) Appl. No.: 14/197,646

(22) Filed: Mar. 5, 2014

Related U.S. Application Data
(60) Provisional application No. 61/774,389, filed on Mar. 7, 2013.

(51) Int. Cl. B27B 17/00

(52) U.S. Cl. CPC B27B 17/0025
USPC 33/630

(57) ABSTRACT

A telescoping measuring apparatus for releasable attachment to a cutting apparatus provides a telescoping body having plural elongate axially aligned rods having measuring indicia thereon, a first clamp assembly and a second clamp assembly for releasable attachment of the measuring apparatus at a position above a cutting apparatus and a marking index to provide a length measurement from a cutting apparatus cutting element.

### RELATED APPLICATIONS

This application claims the benefit of earlier filed U.S. Provisional Patent Application No. 61/774,389 titled FIREWOOD LENGTH MEASURING APPARATUS FOR RELEASABLE ATTACHMENT TO A CHAINSAW filed on Mar. 7, 2013. The entire contents of said U.S. Provisional Patent Application No. 61/774,389 are expressly incorporated herein by this reference.

### BACKGROUND OF INVENTION

1. Field of Invention

This invention relates to measuring apparatus, and more particularly to a telescoping measuring apparatus.

2. Background and Description of Prior Art

Use of wood burning stoves and fireplaces for domestic heating is on the rise as the population seeks additional and alternative sources of heating fuel. As use of wood burning stoves and fireplaces increases, so does the demand for firewood.

Wood burning stoves and fireplaces frequently have fire boxes that are designed and engineered to accommodate specific lengths of firewood. The most common firewood length is 16-18 inches, although such lengths range from 12 to 36 inches. Lengths in excess of design standards will generally not fit through stove doors or lie flat on a fire box rack. Lengths shorter than design standards use fire box space inefficiently and lead to a loss of heat generating capacity. Consistent lengths also make stacking, transport and storage of firewood easier and safer.

Chainsaws are an efficient and popular tool for cutting firewood and public records indicate more than three million new chainsaws are sold in the United States each year. Absent a length measuring apparatus, however, chainsaws are not particularly precise or delicate in their cutting ability and chainsaws do not have any means to assist a user in cutting firewood into consistent lengths.

A common method of measuring and marking firewood into uniform lengths prior to cutting involves the use of a stick having a desired length and a hatchet. The stick is placed upon or immediately adjacent a log to be cut and the hatchet is used to score the log immediately adjacent one end of the stick. Thereafter, the stick is repositioned at the score mark and the process is repeated along the length of log being measured and marked. Such process is time-consuming because a stick of desired length must be procured and said stick must be repeatedly positioned and the measuring must be started and completed before the cutting may commence. This method is also dangerous because a hatchet is used to create the measurement mark. Various other methods to measure and mark lengths of firewood are known such as extending a tape measure on the length of log to be cut and thereafter marking of the log at desired intervals with a visual marking tool such as paint or chalk or wax, and thereafter cutting the log at the marked locations. Unfortunately, these and other known methods have similar disadvantages of time consumption, dangerousness inefficiency of movement and the requirement of tools and apparatus separate from the chainsaw which may be lost, forgotten or subject to failure and breakage.

My invention aims to resolve these and other disadvantages inherent in known firewood measuring apparatus by providing a telescoping body comprised of plural elongate rods, plural releasable attachment means and a marking index to measure desired lengths of firewood and allow measuring while cutting.

My invention does not reside in any of the foregoing features individually but rather in the synergistic combination of all of its structures, which necessarily give rise to the functions flowing therefrom as herein specified and claimed.

### SUMMARY

A telescoping measuring apparatus for releasable attachment to a cutting apparatus provides a telescoping body having plural elongate axially aligned rods each having measuring indicia thereon, a first clamp assembly and a second clamp assembly for releasable attaching the telescoping measuring apparatus to a cutting apparatus and a marking index to provide a length and measurement.

In providing such an apparatus it is:

a principal object to provide a measuring apparatus releasably attachable to a cutting apparatus for repeatedly measuring and cutting uniform lengths.

a further object to provide an apparatus allowing a user to measure firewood into consistent length segments while cutting the firewood.

a further object to provide an apparatus that makes cutting firewood more efficient by eliminating the need to measure firewood into consistent lengths before cutting.

a further object to provide such apparatus having plural axially telescoping members to allow expansion and contraction of the measuring apparatus to provide for different length measurements.

a further object to provide such an apparatus wherein telescoping members have measuring indicia thereon showing a distance measurement from an identified location.

a further object to provide such an apparatus that is releasably attachable to a chainsaw.

a further object to provide such an apparatus that is releasably attachable to a chainsaw handle.

a further object to provide such an apparatus that is releasably attachable to a chainsaw chain brake.

a further object to provide such a measuring device that is operable separately from a cutting apparatus.

a further object to provide such an apparatus wherein the marking index physically marks the material being cut.

a further object to provide such an apparatus that may extend from both lateral sides of the cutting apparatus.

a further object to provide such an apparatus that makes measurements.

a further object to provide such an apparatus to measure and mark arcs.

a further object to provide such an apparatus to measure and mark straight lines a distance from an edge.

a further object to provide such a measuring apparatus that is rigid.

a still further object to provide such apparatus that is of new and novel design, of a rugged and durable nature, of simple and economic manufacture and use and one that is otherwise well suited to the uses and purposes for which it is intended.

Other and further objects of my invention will appear from the following specification and accompanying drawings which form a part hereof. In carrying out the objects of my invention it is to be understood that its features are susceptible to change in design and structural arrangement with only one preferred and practical embodiment of the best known mode being illustrated in the accompanying photographs and specified, as is required.

### BRIEF DESCRIPTIONS OF DRAWINGS

Specific forms, configurations, embodiments and/or diagrams relating to and helping to describe preferred versions of my invention are explained and characterized herein, often with reference to the accompanying drawings. The drawings and all features shown therein also serve as part of the disclosure of my invention of the current application whether described in the text or by graphical disclosure. Such drawings are briefly described below wherein like numbers and references refer to similar parts throughout:

FIG. 1 is an isometric top, front and first side view of a chainsaw cutting apparatus carrying the telescoping measuring apparatus mounted to the chainsaw handle with the telescoping members fully contracted.

FIG. 2 is an isometric front and the top view of the telescoping measuring apparatus of FIG. 1.

FIG. 3 is an enlarged partial cut-away isometric bottom and side view of the second clamp assembly.

FIG. 4 is an enlarged partial cut-away isometric front and top view of the first clamp assembly.

FIG. 5 is an isometric side and end view of the flexible marking index attached to an end of a telescoping member.

FIG. 6 is a partial cut-away orthographic view of the telescoping measuring apparatus less the clamp assemblies showing the marking indicia with the telescoping members partially extended.

FIG. 7 is an isometric top, front and second side view of a chainsaw carrying the telescoping measuring apparatus in use cutting a segment of firewood.

FIG. 8 is an orthographic top, downward looking view of the telescoping measuring apparatus having clamp assemblies configured for attachment to a chainsaw chain brake.

FIG. 9 is a partial cut-away orthographic side view of a marking adapter releasably attachable to an end of the telescoping measuring apparatus for carrying a marking plan for making visible marks on material being measured.

FIG. 10 is a partial cut-away orthographic side view of a T square adapter releasably adjustably attached to the telescoping measuring apparatus for making straight lines of the measurement from an edge and to make arcs.

FIG. 11 is an orthographic back view of the T square adapter of FIG. 10 removed from the telescoping measuring apparatus showing the pivot indexes.

### DESCRIPTION OF PREFERRED EMBODIMENT

The readers of this document should understand that the embodiments described herein may rely on terminology used in any section of this document and other terms readily apparent from the drawings and figures and the language common therefore as may be known in a particular art and such as known or indicated or provided by dictionaries. Dictionaries were used in the preparation of this document. Widely known and used in the preparation hereof are Webster's Third New International Dictionary (©1993), The Oxford English Dictionary (Second Edition, ©1989), The New Century Dictionary (©2001-2005) and the American Heritage Dictionary of the English Language (4th Edition ©2000) all of which are hereby incorporated by reference for interpretation of terms used herein, and for application and use of words defined in such references to more adequately or aptly describe various features, aspects and concepts shown or otherwise described herein.

This document is premised upon using one or more terms or features shown in one embodiment that may also apply to or be combined with other embodiments for similar structures, functions, features and aspects of the invention and provide additional embodiments of the invention. Wording used in the Claims is also descriptive of the invention and the text of both Claims and Abstract are incorporated by reference into the description entirely. Terminology used with one, some or all embodiments may be used for describing and defining the technology and exclusive rights associated herewith.

### Overview of the Apparatus

As used herein, the term “bottom”, its derivatives, and grammatical equivalents refers to that portion of the apparatus closest to the material being cut. The term “top”, its derivatives, and grammatical equivalents refers to that portion of the apparatus vertically furthest from the material being cut. The term “outer” its derivatives, and grammatical equivalents refers to that portion of the apparatus laterally offset from a laterally medial portion of the apparatus.

A telescoping measuring apparatus for releasable attachment to a cutting apparatus 50 generally provides a telescoping body 20, a first clamp assembly 30, a second clamp assembly 40 and a marking index 26.

The body 20 is comprised of a first member 21, a second member 22 and a third member 23. Each member 21, 22 and 23 is elongate and preferably tubular in configuration each member 21, 22 and 23 defined in a medial channel (not shown) extending therethrough. The second member 22 is movably axially carried within the medial channel (not shown) defined by the first member 21. The second member 22 similarly defines a medial channel (not shown) extending therethrough in which is movably axially carried the third member 23. The first member 21, the second member 22 and the third member 23 each have a first end portion hereinafter designated by the letter “A” and a second end portion hereinafter designated by the letter “B”. In the current preferred embodiment the members 21, 22 and 23 are cylindrical and tubular in configuration, however it is also contemplated that the members 21, 22 and 23 may be formed having configurations other than tubular, such as, but not limited to, square, rectilinear, oval, flat bar and the like that are configured to telescope relative to one another.

A first collar 24 is carried at the first end portion 21A of the first member 21 and a second collar 25 is carried at the first end portion 22A of the second member 22. The collars 24, 25 are friction type fittings known in the industry, and are either axially rotatable relative to the immediately adjacent inner member 22 and 23 or carry a thumbscrew (not shown) to positionally secure the members 21, 22, 23 relative to one another. Axial rotation of collar 24, relative to the second member 22 causes collar 24 to “tighten” about an outer circumferential surface 28 of the second member 22 which responsively positionally secures the second member 22 relative to the first member 21. Similarly, axial rotation of collar 25, relative to the third member 23 causes the collar 25 to “tighten” about an outer circumferential surface 29 of the third member 23 which responsively positionally secures the third member 23 relative to the second member 22. Loosening the collars 24, 25 relieves frictional engagement and allows the second member 22 to move axially relative to the first member 21, and allows the third member 23 to move axially relative to the second member 22. Axial movement of the members 22, 23 relative to the first member 21 allows the apparatus to be expanded and contracted by the user as desired.

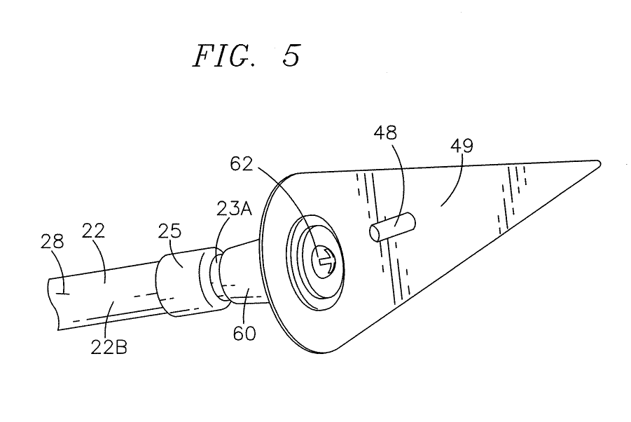

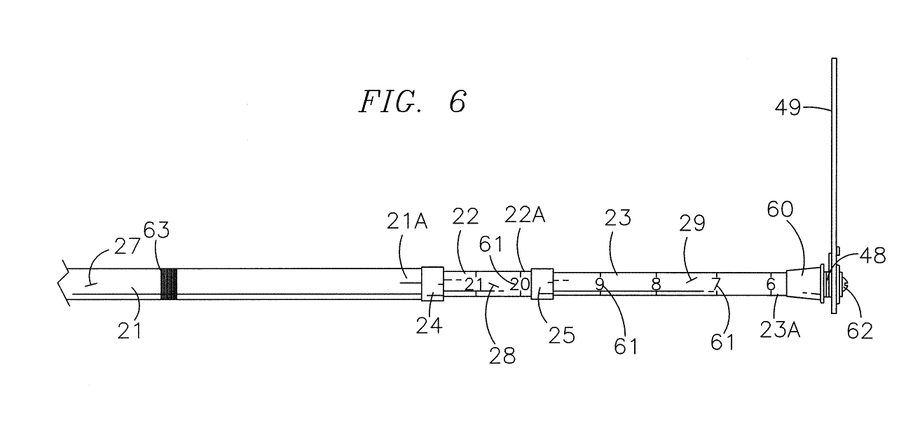

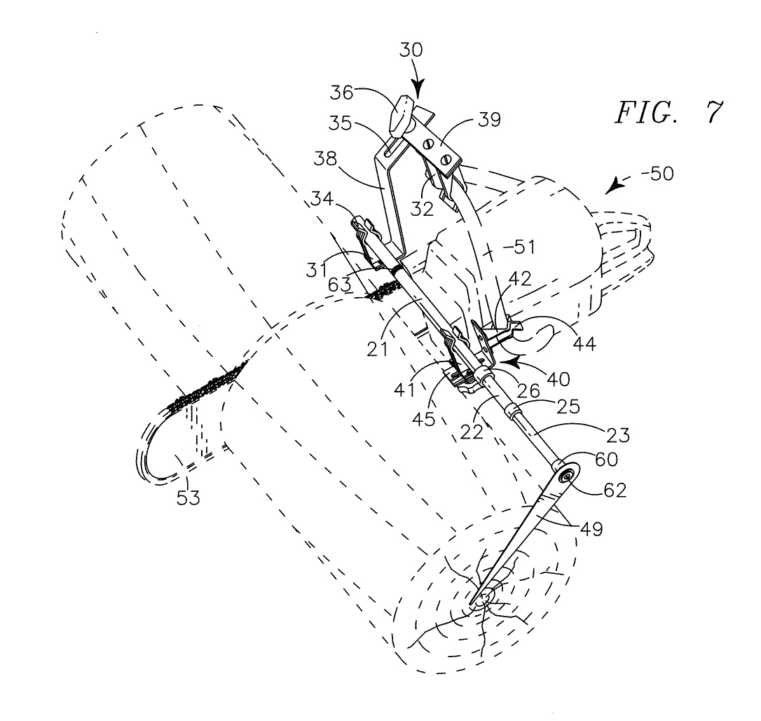

As shown in FIG. 6, the first member 21, the second member 22 and the third member 23 each carry measuring indicia 61 on outer circumferential surfaces 27, 28, 29 allowing a user to quickly and easily determine the distance between the marking index 49 carried at the third member first end portion 23A, and a chainsaw cutting element 53. (Commonly known as the chainsaw bar which should be aligned with the chain line 63 on the first member 21).

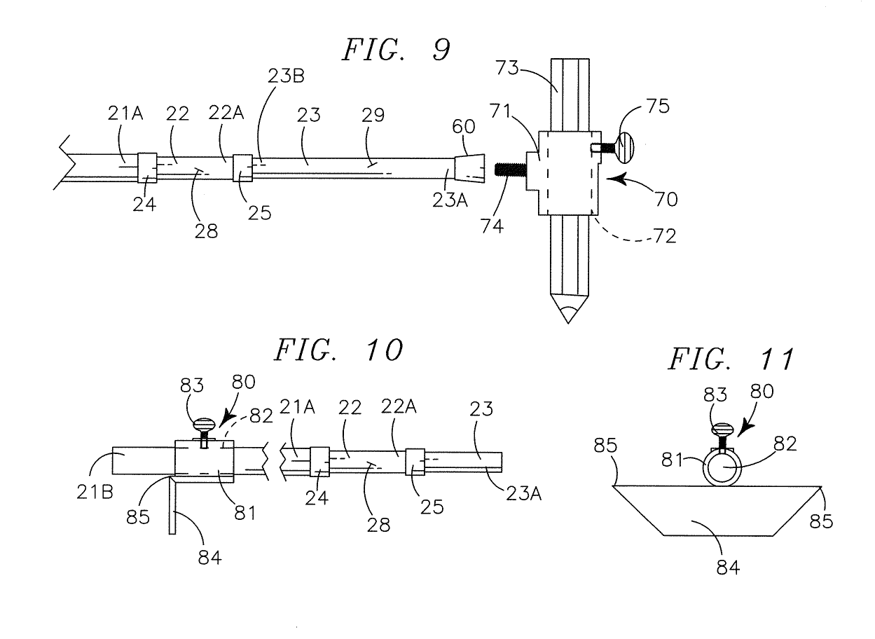

End cap 60 is carried at the third member 23 first end portion 23A. The end cap 60 is preferably formed of a resilient material such as plastic or rubber and extends diametrically across end of the medial channel (not shown) defined by the third member 23 and may be carried within the medial channel (not shown) similar to a plug. The end cap 60 may also extend circumferentially about outer circumferential surface 29 of the third member 23. The end cap 60 provides an attachment point for marking index 49 which is preferably secured to thereto with a known threaded fastener 62 so that the marking index 49 extends radially from the third member 23 first end 23A. The end cap 60 also provides an attachment point for a marking adapter 70 (FIG. 9).

The marking index 49 is preferably formed of a brightly colored resiliently deformable material that has sufficient rigidity to extend radially from the third member 23 first end portion 23A at any angle. (horizontally, vertically, etc.). In the preferred embodiment, the marking index 49 is positionally spring biased 48 relative to the end cap 60 to allow radial movement of the marking index 49 relative to the end cap 60 to promote and maintain durability by allowing the marking index 49 to move radially as opposed to bending/flexing which over time may cause the marking index 49 to break.

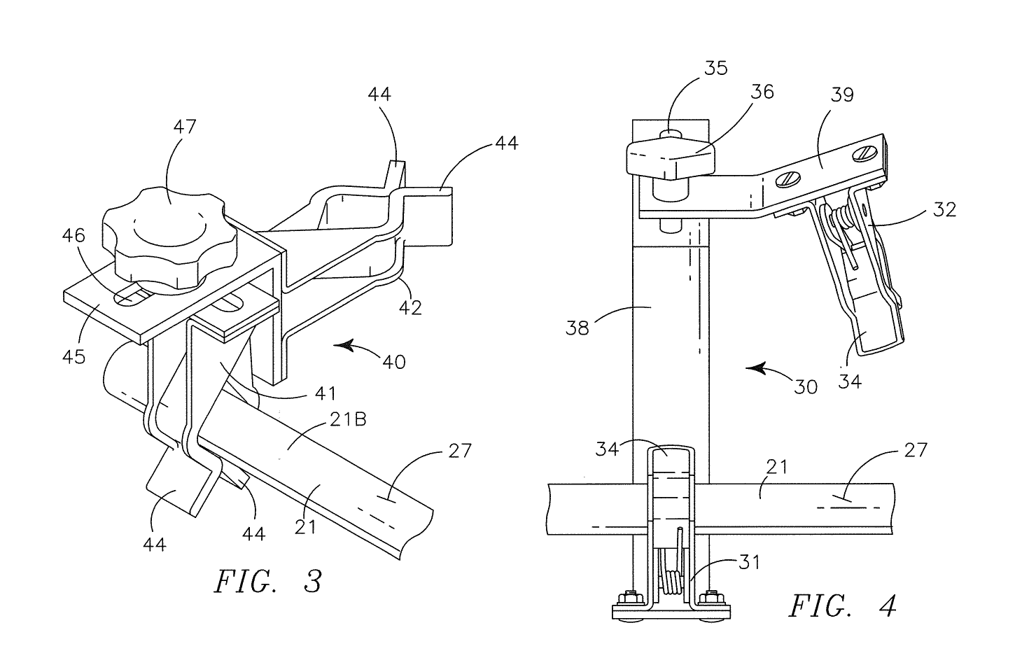

As shown in FIG. 4, first clamp assembly 30 has a body clamp 31, a handle clamp 32 and offsetting brackets 38, 39 providing an attachable adjustment means 33 therebetween. The body clamp 31 is carried at one end portion of offset bracket 38 and is of known construction having two opposing outwardly flared end portions 34 to ease engagement with the outer circumferential surface 27 of first member 21. Body clamp 31 is spring biased to a closed position to frictionally engage with an outer circumferential surface 27 of the first member 21. The handle clamp 32 is carried at one and a portion of offset bracket 39 and is similarly of known construction and frictionally engages with a portion of chainsaw handle 51. Handle clamp 32 is likewise spring biased to a closed position to cause frictional engagement and positional maintenance with the chainsaw handle 51. Adjustment means 33 includes a gripping knob 36 carrying a threaded stud (not shown) extending through and elongated hole 35 defined in offsetting bracket 38 for engagement with a threaded nut (not shown). The offsetting brackets 38, 39 and gripping knob 36 provide adjustability between the body clamp 31 and the handle clamp 32 providing adjustability for the first clamp assembly 30 to accommodate varying types and sizes of chainsaws 50 wherein the chainsaw handles 51 may be configured differently and also permits user adjustments to ensure the telescoping measuring apparatus does not interfere with the chainsaw 50 operation. In the preferred embodiment, the first clamp assembly 30 is positioned proximate to the first member 21 first end portion 21A.

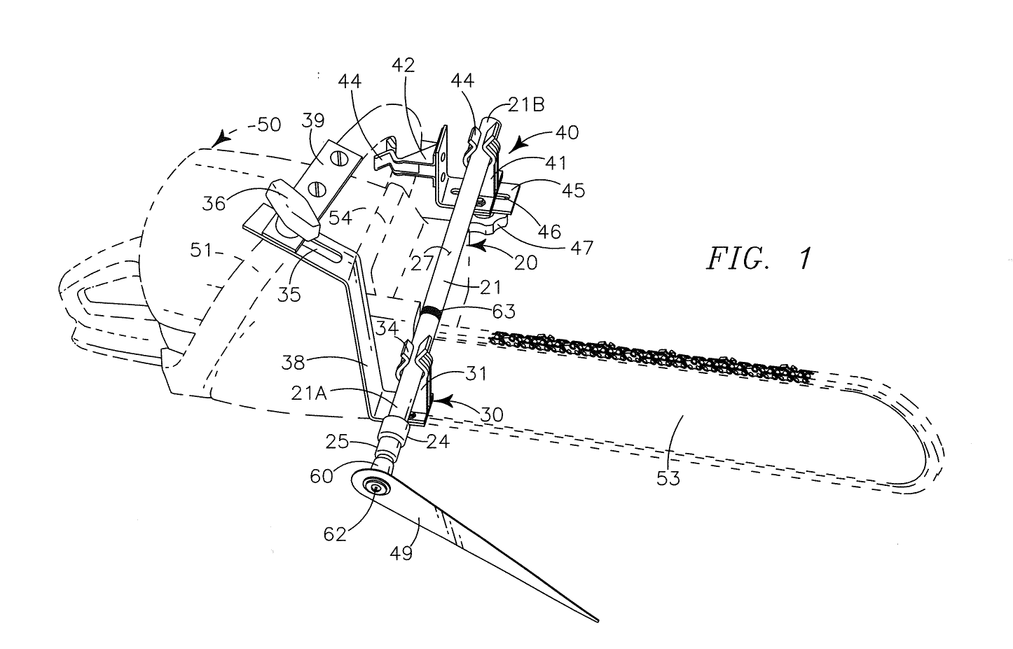

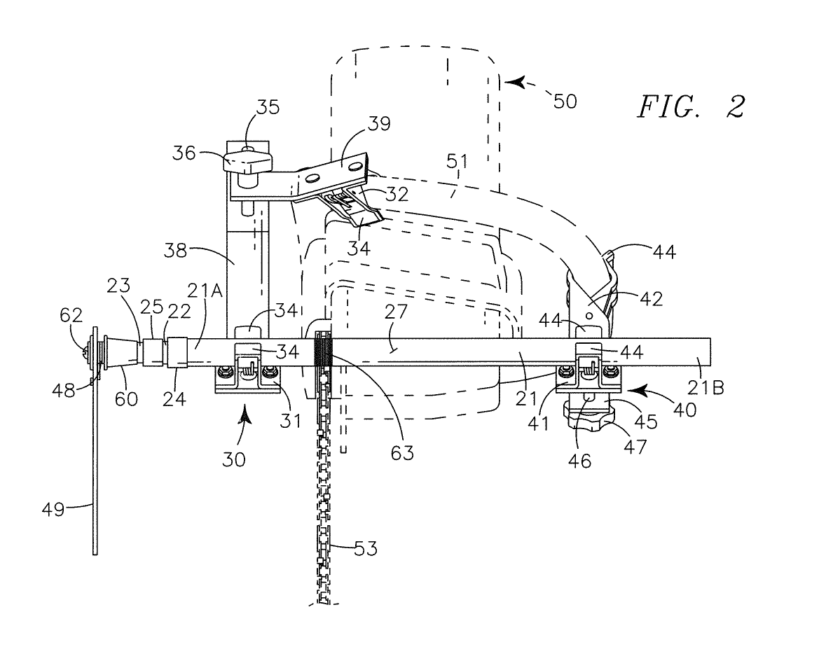

As shown in FIG. 4, second clamp assembly 40 has a body clamp 41, a handle clamp 42 and an angle bracket 45 providing an adjustment means therebetween. In the preferred embodiment, the second clamp assembly 40 is positioned proximate second end portion 21B of the first member 21. (FIG. 1). The body clamp 41 is of known construction and has opposing outwardly flared end portions 44 to ease engagement with the first member 21, and is spring biased to a closed position to frictionally engage with an outer circumferential surface 27 of the first member 21. The handle clamp 42 is of similar known construction and is carried by the angle bracket 45. The handle clamp 42 frictionally engages with a portion of the chainsaw handle 51. The handle clamp 42 is similarly spring biased to a closed position to cause frictional engagement and positional maintenance therebetween. Angle bracket 45 is interconnected to the handle clamp 42 and defines an elongated hole 46 in a leg portion opposite the handle clamp 42 for gripping knob 47 carrying a threaded stud (not shown) to extend therethrough to adjustably engage with the body clamp 41 to provide adjustability between the body clamp 41 and the handle clamp 42 providing adjustability for the second clamp assembly 40 to accommodate varying types and sizes of chainsaw handles 51 and also permits user adjustments to ensure the telescoping measuring apparatus does not interfere with the chainsaw 50 operation.

The construction of, and spring biasing of, the body clamps 31, 41 and in particular the opposing outwardly flared end portions 34, 44 permit the body 20 to be withdrawn from the body clamps 31, 41 without having to directly manipulate the body clamps 31, 41. A user grasping the body 20 may remove the body 20 from the body clamps 31, 41 by pulling the body 20 away from the clamps 31, 41. The absence of “locking means” provides an additional safety feature because the body 20 is detachable from the first and second clamp assemblies 30, 40, respectively, if the chainsaw were to somehow become “bound up” during use. Further the first and second clamp assemblies 30, 40 do not interfere with the chainsaw 50 chain brake which is a mandatory safety feature for all chainsaws 50. The absence of any locking means between the body 20 and the clamp assemblies 30, 40 is important because activation of the chainsaw brake may cause the body 20 to be rapidly separated from the first and second clamp assemblies 30, 40. Any device or apparatus that impedes such separation could foreseeably be hazardous to the user.

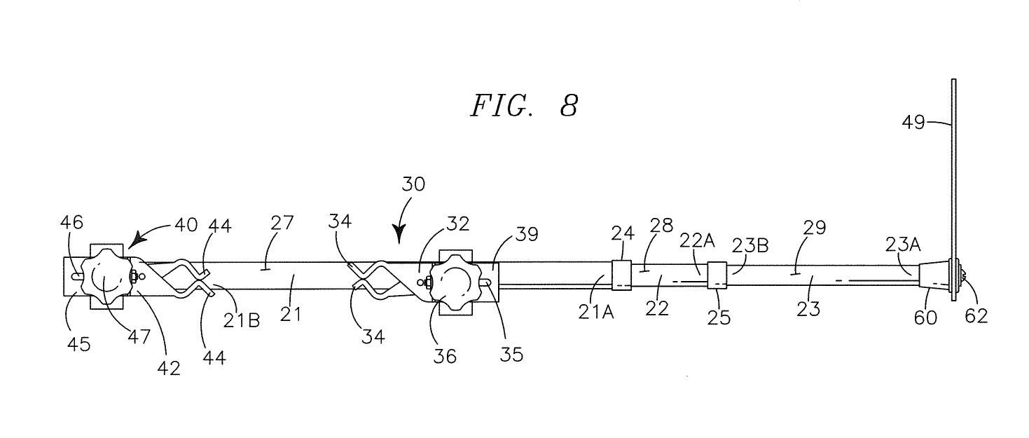

In another preferred embodiment, (FIG. 8) the first clamp assembly 30 and the second clamp assembly 40 may be adjustably positioned to releasably engage with the chainsaw 50 chain brake 54 rather than releasably engage with the chainsaw handle 51.

As shown in FIGS. 9, 10 and 11 a marking tool adapter 70 and a T square adapter 80 may be releasably attached to the body 20 to allow additional uses of my telescoping measuring apparatus. It is envisioned the marking tool adapter 70 and the T square adapter 80 may be used in conjunction with one another or separately depending upon the desires of the user. Further, it is contemplated the marking tool adapter 70 and the T square adapter 80 may be used when the telescoping measuring apparatus is removed from the cutting apparatus 50.

The marking tool adapter 70 (FIG. 9) allows a user to make a visible mark on a surface to be cut which might be desirable if one is attempting to count the number of segments that might be cut from a log, or when a user desires to mark measurements without interconnecting the body 20 to a cutting apparatus 50. The marking tool adapter 70 has a marker body 71 defining a medial channel 72 extending therethrough in which may be carried a marking tool 73 such as but not limited to, a wax crayon, a carpenter's pencil, a scribe, a knife or similar marking device to make a visible mark on, scribe or cut the material. A releasable attachment means 74, such as, but not limited to, a threaded stud is carried by the marker body 71 and extends generally perpendicular to an axis (not shown) of the medial channel 72 so that the marking tool 73 extends generally radially from the body 20 of the telescoping measuring apparatus. A thumbscrew 75 is also carried by the marker body 71 in a threaded hole (not shown) communicating with the medial channel 72 to provide and easily adjustable means to adjustably positionally secure a marking tool 73 in the medial channel 72. It is contemplated the marking tool adapter 70 may be releasably attached to the end cap 60 carried at the second end portion 21B of the first member 21, or in place of the marking index 49 at the first end portion 23A of the third member 23. It is further contemplated the marking tool adapter 70 will be useful in marking and measuring arcs by fixing an end portion A or B of the body 20 to a point (not shown) with a T-square adapter 80 and moving the opposing end portion A, B of the body 20 about the fixed point so that the marking tool 73 creates a visible arc (not shown) on the surface to be cut.

As shown in FIGS. 10 and 11, a T square adapter 80 may be releasably attached to the body 20 to allow a user to mark and/or cut a straight line measurement a consistent distance from an edge of a piece of plywood (not shown) or drywall (not shown) or similar large planar material. The T square adapter 80 has a T square body 81 defining a medial channel 82 extending therethrough. The medial channel 82 is preferably configured and sized to slidably fit over and about the outer circumferential surface 27 of the first member 21 proximate the second end portion 21B. A thumbscrew 83 is carried in a threaded hole (not shown) defined in the T square body 81. The threaded hole (not shown) communicates with the medial channel 82 so that the thumbscrew 83 may be tightened and loosened to positionally secure the T square body 81 in positional engagement with the first member 21 allowing nearly infinite measurement adjustments. A slide wall 84 is carried by the T square body 81 preferably at a position diametrically opposite the thumbscrew 83 so that the thumbscrew 83 does not interfere with any measurement taking. The slide wall 84 is aligned perpendicular to the medial channel 82 and is preferably elongated end-to-end to ensure ease of movement of the slide wall 84 along an edge (not shown) of a material to be measured. It is further contemplated opposing corner portions of the slide wall 84 are configured into an axis pivot point 85 about which the body 20 may pivot when used to mark an arc on the material being measured.

### Construction and Materials of the Apparatus

The first member 21, second member 22 and third member 23 as well as the first clamp assembly 30 and the second clamp assembly 40 are preferably formed of aluminum due to aluminum's lightweight, durability and economic availability but it is also contemplated the members 21, 22, 23 and clamp assemblies 30, 40 may likewise be formed of plastic or composite or other more economical material. The collars 24, 25, end cap 60, marking tool adapter 70 and T square adapter 80 are preferably formed of the molded plastic. The marking index 49 is preferably formed of a flexible resiliently deformable plastic.

Having described the structure of my TELESCOPING MEASURING APPARATUS FOR RELEASABLE ATTACHMENT TO A CUTTING APPARATUS, its operation may be understood.

The first clamp assembly 30 is grasped by the user and the handle clamp 32 is interconnected with the chainsaw handle 51 distal from the chainsaw cutting element 53. In order to interconnect the handle clamp 32 with the chainsaw handle 51 it may be necessary to spread apart the outwardly flared end portions 34 of the handle clamp 32 so that the handle clamp 32 engages generally circumferentially about the chainsaw handle 51 and the spring biasing of the handle clamp 32 positionally secures the handle clamp 32 to the chainsaw handle 51. The offset brackets 38, 39 are aligned so that the brackets 38, 39 may be interconnected and the threaded stud (not shown) of the gripping knob 36 passes through the elongated hole 35 defined in offset bracket 38. The gripping knob 36 is tightened to positionally secure offset brackets 38, 39 relative to one another so that the body clamp 31 carried at a second end portion of the offset leg 38 is positioned spacedly above and laterally adjacent the chainsaw cutting element 53.

The second clamp assembly 40 handle clamp 42 is interconnected with the chainsaw handle 51 above and laterally distal from the chainsaw cutting element 53. In order to interconnect the handle clamp 42 with the chainsaw handle 51 it may be necessary to spread apart the outwardly flared end portions 44 of the handle clamp 42 so that the handle clamp engages generally circumferentially about the chainsaw handle 51 and the spring biasing of the handle clamp 42 positionally secures the handle clamp 42 to the chainsaw handle 51. The angle bracket 45 which is carried by the handle clamp 42 should extend forwardly from the chainsaw handle 51 generally parallel with the chainsaw cutting element 53. The body clamp 41 is positioned the immediately adjacent the angle bracket 45 so that the threaded stud (not shown) of the gripping knob 47 passes through the elongated hole 46 defined in the angle bracket 45 and the threaded stud (not shown) engages with the body clamp 41 and thereafter the gripping knob 47 is tightened to secure the body clamp 41 to the angle bracket 45. The two body clamps 31, 41 are aligned with the horizontally and vertically relative to the chainsaw cutting element 53 so that the body 20 may be simultaneously engaged with both body clamps 31, 41.

The body 20 is positioned vertically above and forward of the body clamps 31, 41. The outwardly flared end portions 34, 44 of the body clamps 31, 41 respectively may be manually forced apart to allow the body 20 to pass therebetween so that the body clamps 31, 41 frictionally engage with the outer circumferential surface 37 of the first member 21 due to the spring biasing of the body clamps 31, 41. In the preferred configuration, the measuring index 49 carried at the first end portion 23A is positioned proximate the chainsaw cutting element 53. The body 20 extends generally laterally across a front portion of the chainsaw 50 generally perpendicular to the cutting element 53. The adjustment means 33, 43 of the first clamp assembly 30 and the second clamp assembly 40 are tightened to positionally secure the body 20 in the desired location and to prevent undesirable vibration or movement. The body 20 is positionally adjusted relative to the chainsaw 50 and the first and second clamp assemblies 30, 40 respectively so that a chain line 63 mark on the first member 21 (FIG. 8) is aligned with the chainsaw cutting element 53.

The first collar 24 and the second collar 25 are loosened and tightened as desired in order to axially extend and retract the second member 22 and the third member 23 from the first member 21. The measuring indicia 61 on outer circumferential surfaces 27, 28, 29 of the first member 21, the second member 22 and the third member 23 provide the user with an accurate distance measurement between the chainsaw cutting element 53 and the measuring index 49.

When a user wants to cut firewood into 24″ lengths, the user would loosen the second collar 25 securing the third member 23 in the second member 22 and extend the third member 23 axially outwardly from the second member 22 until the 18″ marking indicia 61 is revealed. The user would then tighten the second collar 25 to positionally secure the third member 23 at this length position. The user would loosen the first collar 24 and axially extend the second member 22 relative to the first member 21 by drawing the second member 22 axially from the first member 21 until the measuring indicia 61 on the outer circumferential surface 28 of the second member 22 indicates 24″. The first collar 24 is then tightened securing the second member 22 to the first member 21 at the desired extended length.

Placing the measuring index 49 immediately adjacent an end portion of the log being cut (FIG. 9) and then operating the chainsaw 50 normally allows the user to repeatedly cut the same length of firewood. Loosening and thereafter tightening the collars 24, 25 allows the position of the marking index 49 to be extended outwardly from, or contracted inwardly toward the chainsaw cutting element 53 to alter the length of firewood desired. The length distance between the chain line 63 and the first end 21A of the first member 21, and the length of the collars 25, 26 is “built into” or “otherwise taken into account” in the measuring indicia 61 on the members 21, 22, 23 so that the first (laterally outermost) measuring indicia 61 on the third member 23 is not “0” inches. It is contemplated however that a distinguishable second set of marking indicia (not shown) (such as in a different color, or in different font) may be carried on the members 21, 22, 23 to measure an accurate distance from the end 23A of the third member 23 for use with the adapters 70, 80 such as when a user is making an arc, or a straight line measurement from an edge.

For storage, and to protect the apparatus, the tubular members 22, 23 should be fully retracted into the medial channel (not shown) of the first member 21.

It is contemplated to my telescoping measuring apparatus may also be detached from the body clamps 31, 41 and used independently as a telescoping measuring and a marking apparatus with and without the marking tool adapter 70 and/or with and without the T square adapter 80.

### INTERPRETATION NOTES

The above description has set out various features, functions, methods and other aspects of my invention. This has been done with regard to the currently preferred embodiments thereof. Time and further development may change the manner in which the various aspects are implemented. Such aspects may further be added to by the language of the claims which are incorporated by reference. The scope of protection accorded my invention, as defined by the claims, is not intended to be necessarily limited to the specific sizes, shapes, features or other aspects of the currently preferred embodiment shown and described. The claimed invention may be implemented or embodied in other forms still being within the concepts shown, described and claimed herein. Also included are equivalents of the invention which can be made without departing from the scope or concepts properly protected hereby.

The foregoing description of my invention is necessarily of a detailed nature so that a specific embodiment of a best mode may be set forth as is required, but it is to be understood that various modifications of details, sizes, and rearrangement, substitution and multiplication of the parts may be resorted to without departing from its spirit, essence or scope.

Having thusly described my invention, I hereby file this Utility Patent Application and pray for issuance of Utility Letters Patent.

The foregoing description of my invention is necessarily of a detailed nature so that a specific embodiment of its best mode may be set forth as is required, but it is to be understood that various modifications of details, and rearrangement, substitution and multiplication of parts may be resorted to without departing from its spirit, essence or scope.

Having thusly described my invention, I claim:

1. A telescoping measuring apparatus releasably attachable to a cutting apparatus to measure while cutting comprising in combination:
a body having plural axially aligned axially movable members, each axially aligned member having a first end portion and a spaced apart second end portion;
a clamp assembly releasably attachable to the body and releasably attachable to the cutting apparatus to positionally maintain the telescoping measuring apparatus relative to a cutting element of the cutting apparatus;
a marking index carried at one end portion of an axially aligned member; and
visible marking indicia on the axially movable members providing a distance measurement between the marking index and the cutting apparatus cutting element.

2. The telescoping measuring apparatus of claim 1 wherein:
the body has a first member, that is tubular defining a medial channel extending therethrough in which a second member is axially movably carried, and
the second member is tubular defining a medial channel extending therethrough in which is carried a third member that is axially movable therein.

3. The telescoping measuring apparatus of claim 1 further comprising:
a clamp assembly having a body clamp for releasable engagement with the body and a handle clamp for releasable engagement with the cutting apparatus.

4. The telescoping measuring apparatus of claim 1 wherein:
the telescoping measuring apparatus is releasably attachable to a chainsaw to permit a user to measure firewood into consistent lengths while cutting the firewood into segments having consistent lengths.

5. The telescoping measuring apparatus of claim 4 wherein:
the telescoping measuring apparatus is releasably attachable to a chainsaw handle; and
the body is positioned above a chainsaw cutting element and forwardly from a chainsaw motor.

6. The telescoping measuring apparatus of claim 4 wherein:
the telescoping measuring apparatus is releasably attachable to a chainsaw chain brake.

7. A telescoping measuring apparatus releasably attachable to a cutting apparatus comprising in combination:
a body having plural axially aligned axially movable members, each axially aligned member having a first end portion and a spaced apart second end portion;
a marker adapter carried at one end portion of an axially aligned member, the marker adapter having a marker body releasably adjustably carrying a marking tool to make a visible mark on a material being measured; and
visible marking indicia on the axially movable members providing a measurement between the marking tool and the opposing end of the body.

8. The telescoping measuring apparatus of claim 7 further comprising:
a T-square adapter having a T-square body defining a medial channel extending therethrough in which the body adjustably extends;
a thumb screw carried in a threaded hole defined in the T-square body to positionally secure the T-square body to the body at a determined position; and
a slide wall carried by the T-square body extending perpendicular to the medial channel and opposite the thumb screw to slide along an edge portion of a material to be measured, allowing the marking tool to make a consistent visible marked measurement from the edge portion.

9. The telescoping measuring apparatus of claim 8 further comprising:
an indexing point on the T-square adapter to allow the telescoping measuring apparatus to pivot thereabout to measure and mark arcs with a marking tool carried on an end portion of the body opposite the T-square adapter.
